(19) United States
(12) Patent Application Publication
(10) Pub. No.: US 2003/0007616 A1
(43) Pub. Date: Jan. 9, 2003

(54) System and method for providing customized caller ID information

(75) Inventors: David Alves, Sudbury, MA (US); Thomas Ward, Conch Key, FL (US); John Welch, Billerica, MA (US)

Correspondence Address: BOURQUE & ASSOCIATES, P.A., 835 HANOVER STREET, SUITE 303, MANCHESTER, NH, 03104, US

(73) Assignee: Davox Corporation

(21) Appl. No.: 09/898,787

(22) Filed: Jul. 3, 2001

(51) Int. Cl. H04M 11/00; H04M 1/56

(52) U.S. Cl. 379/142.14; 379/142.01; 379/93.17

(57) ABSTRACT

A method and system for customizing caller ID information can be used in a call center or other telephony system to present customized caller ID information to a called party independent of the telephone line from which the call is made in the call center. The system retrieves at least one call record including a telephone number to be called and a customized caller ID telephone number associated with the call record. The number to be called and customized caller ID number are placed in a setup message formatted using an Integrated Services Digital Network (ISDN) protocol. The setup message is sent to the Public Switched Telephone Network (PSTN) to establish a telephonic connection with the called party. If the called party subscribes to the caller ID service, the customized caller ID telephone number and any associated information will be presented to the called party.

### TECHNICAL FIELD

The present invention relates to telephony systems, and more particularly, relates to a system and method for providing customized caller identification (caller ID) information to a called party.

### BACKGROUND INFORMATION

A growing number of companies or business entities have used call centers to handle interactions or communications with customers and potential customers by way of telephone. In one application, the call center places outbound telephone calls on behalf of the business entity, for example, to potential customers for telemarketing and to existing customers for collections. A single call center may be capable of handling a large volume of outbound telephone calls on behalf of one or more business entities.

A typical call center 10, FIG. 1, includes a number of different components. One or more communication devices 12 (e.g., a dialer or digital switch) establish telephonic communications between call center agents and the parties (e.g., customers or potential customers) being called. Many call centers have begun to use the Integrated Services Digital Network (ISDN) to establish telephonic communications between agents and called parties. ISDN is a set of digital transmission protocols for transmitting voice and/or data with signaling carried separately from the voice/data. ISDN defines two types of logical channels—bearer channels (or B channels) carry voice or data and a data channel (or D channel) handles signaling. A call center typically uses a primary rate interface (PRI) ISDN service, for example, a T1 or E1 line 16. One example of a call center communication device 12 that supports ISDN is the Digital Communications Server (DCS) available from Davox Corporation.

The call center 10 also includes agent workstations 18 used by the agents to handle the outbound telephone calls. Each of the agent workstations 18 includes a data terminal, such as a PC 20, for receiving and transmitting data and an audio communications device, such as a headset 22, for receiving and transmitting voice communications. A supervisor workstation 24 can be used by a supervisor or system administrator to oversee the agents and activities in the call center 10.

The typical call center 10 further includes a host system 26 that stores information pertaining to the customer, potential customer, or other called party. The host system 26 typically includes one or more databases of customer or potential customer information, such as customer call records, including customer name and telephone number, account information, and the like.

A call center management system 28 monitors and manages the call center activities, resources and overall performance. The call center management system 28 typically includes one or more servers, for example, implemented using a Windows based operating system or a Unix based operating system, and including software for managing the contact center. Examples of call center management systems include the software available from Davox Corporation under the name UNISON® and the software available from Davox Corporation under the name ENSEMBLET™. The components of the call center 10 are typically interconnected using a local area network (LAN) 29, such as an ethernet.

When a called party receives a telephone call from a call center or any other calling party, the called party often wants to identify the calling party and/or calling party number to decide whether or not to take the call. Many people will not answer a call if their caller ID displays that the calling party information is “unavailable,” “unknown,” or the like. The calling party number information is also useful for the called party should the called party decide to call the calling party back later. The caller ID service offered by telephone companies provides the called party with information about the calling party. The caller ID information has been limited to the information that the telephone company has in its caller ID database for the line of the originating call. Thus, if a called party subscribes to a caller ID service, the called party will see the telephone number for the originating line and may also see the name associated with that number if that name is in the database used by the telephone company processing the call. When a conventional call center places an outbound call, however, because the originating T-span typically has multiple numbers assigned to it, the caller ID information presented to the called party typically appears as “unknown” or “unavailable.” In many cases, one call center is placing outbound calls on behalf of a number of different business entities.

Accordingly, there is a need for a method and system for providing customized caller ID information to a called party independent of the line originating the call. In particular, there is a need for a call center that is capable of customizing caller ID information to be presented to a called.

### SUMMARY OF THE INVENTION

In accordance with one aspect of the present invention, a system and method is provided for customizing caller identification (ID) information. The method comprises retrieving at least one call record including at least a telephone number to be dialed and retrieving a customized caller ID telephone number associated with the call record. A call setup message is formatted using an Integrated Services Digital Network (ISDN) protocol. The call setup message includes the telephone number to be dialed and the customized caller ID telephone number. The call setup message is then sent to the Public Switched Telephone Network (PSTN) via an ISDN D channel, for connecting to a called party having the telephone number to be dialed. The customized caller ID telephone number is displayed to the called party if the called party subscribes to a caller ID service on the PSTN.

According to one embodiment, the call record is associated with a call campaign having a plurality of call records representing outbound calls to be made, and the customized caller ID telephone number is associated with each of the plurality of call records in the call campaign. In one example, the call campaign is being performed on behalf of a business entity, and the customized caller ID telephone number is a telephone number for the business entity. The call setup message is preferably sent over a primary rate interface (PRI) line.

The system for customizing caller identification (ID) information comprises a database for storing a plurality of call records and a call record processor for retrieving at least one call record from the database and for retrieving a customized caller ID telephone number associated with the call record. The call record includes at least a telephone number to be dialed. An Integrated Services Digital Network (ISDN) communications device is coupled to the call record processor for formatting and sending the call setup message using an ISDN protocol.

According to another aspect of the present invention, a call center is capable of providing customized caller identification (ID) information. The call center comprises: a host database for storing a plurality of call records; a call center management system for retrieving and processing call records from the database and for retrieving the customized caller ID telephone number associated with the call records; a plurality of agent workstations for displaying call record information to agents; and a local area network (LAN) connecting the host database, the call center management system, and the agent workstations. An Integrated Services Digital Network (ISDN) communications device is coupled to the call center management system for formatting the call setup message using the ISDN protocol. A plurality of audio communications devices associated with respective ones of the plurality of agent workstations are connected to the ISDN communications device.

According to a further aspect of the present invention, a method is provided for conducting one or more outbound call campaigns in a call center using customized caller ID information. The method comprises creating at least first and second outbound call campaigns for respective first and second business entities. The first and second outbound call campaigns are associated with first and second groups of call records. First and second customized caller ID telephone numbers are associated with respective first and second outbound call campaigns as campaign parameters. The first customized caller ID telephone number is a telephone number of the first business entity, and the second customized caller ID telephone number is a telephone number of the second business entity. The first and second call campaigns are then processed.

Processing the first and second call campaigns includes formatting call setup messages for each of the outbound call campaigns to be transmitted using an ISDN protocol. Each of the call setup messages for the first outbound call campaign includes a telephone number to be dialed from a call record in the first group of call records and includes the first customized caller ID telephone number. Each of the call setup messages for the second outbound call campaign includes a telephone number to be dialed from a call record in the second group of call records and includes the second customized caller ID telephone number. Processing the outbound call campaigns further includes sending the call setup messages over an ISDN line to the PSTN, for attempting to establish telephonic connections with called parties corresponding to the telephone numbers to be dialed. The first customized caller ID telephone number is presented to the called parties having caller ID service and corresponding to the first outbound call campaign. The second customized caller ID telephone number is presented to the called parties having caller ID service and corresponding to the second outbound call campaign.

### DESCRIPTION OF THE DRAWINGS

These and other features and advantages of the present invention will be better understood by reading the following detailed description, taken together with the drawings wherein:

FIG. 1 is a schematic block diagram of a call center, according to the prior art;

FIG. 2 is a schematic block diagram of a system for customizing caller ID information, according to one embodiment of the present invention; and

FIG. 3 is a flow chart illustrating a method for conducting outbound call campaigns with customized caller ID information, according to one embodiment of the present invention.

### DETAILED DESCRIPTION OF THE PREFERRED EMBODIMENT

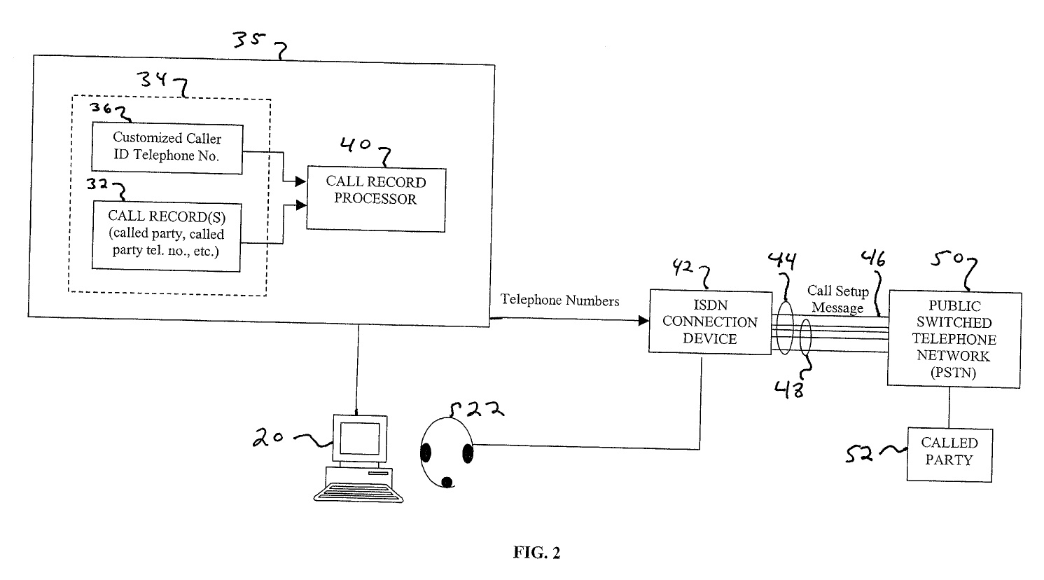

A system 30 for customizing caller ID information, according to the present invention, as shown in FIG. 2, uses an ISDN protocol to send a customized caller ID telephone number to a called party independent of the line originating the call. According to the exemplary embodiment, the system 30 of the present invention is used in a call center, as will be described in greater detail below. One example of a call center in which the present invention can be implemented is described in greater detail in U.S. Pat. No. 5,592,543, which is commonly assigned with the present application and incorporated herein by reference. One version of the system disclosed in U.S. Pat. No. 5,592,543 is currently known as the UNISON® system available from Davox Corporation. Another example of a call center system in which the present invention can be implemented is known as the ENSEMBLET™ system also available from Davox Corporation. The method and system 30 of the present invention can also be used in other telephony applications in which there is a need to customize caller ID information.

The system 30 includes a plurality of call records 32, for example, stored in a database 34. Each of the call records 32 includes at least one telephone number to be dialed in addition to other information pertaining to the party to be called. A customized caller ID telephone number 36 is associated with one or more of the call records 32 and can also be stored in the database 34. The customized caller ID telephone number 36 is preferably a telephone number that can be called back by the called party or parties identified in the one or more call records 32 associated with the customized caller ID telephone number 36.

A call record processor 40 retrieves one or more of the call records 32 and the customized caller ID telephone number 36 associated with the call record(s). As shown in FIG. 2, the call record processor 40 may reside on the same server 35 as the database 34 or, alternatively, may reside on a remote server (not shown). The call record processor 40 then sends the customized caller ID telephone number 36 along with the telephone number to be dialed to an ISDN connection device 42. The ISDN connection device 42 is preferably connected to a primary rate interface (PRI) line 44, such as a T1 line, including a D channel 46 and 23 B channels 48.

The ISDN connection device 42 places the telephone number to be dialed and the customized caller ID telephone number in a call setup message formatted according to an ISDN protocol. The call setup message is sent by the ISDN connection device 42 to the PSTN 50 to establish a telephonic connection with the called party 52. If the called party 52 subscribes to the caller ID service through the telephone company, the customized caller ID telephone number 36 (and any associated information in the telephone company caller ID database) is presented to the called party 52 even though the call originated from a line having a different telephone number.

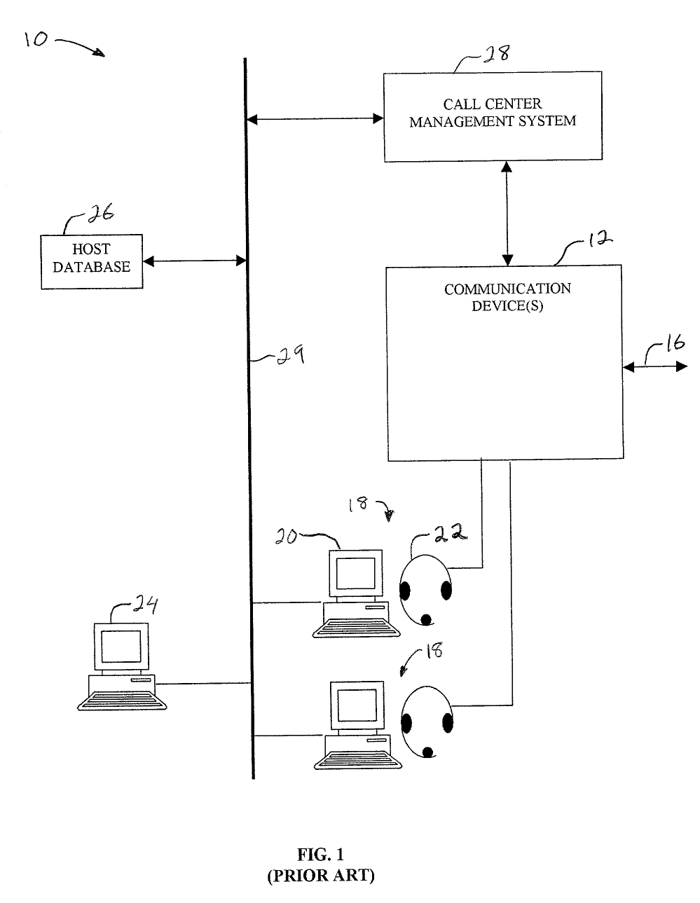

According to the exemplary embodiment, the call records 32 are customer call records stored in the host database 26 in the call center 10 (see FIG. 1). The call records 32 can be associated with one or more outbound call campaigns. An outbound call campaign represents a series of telephone calls to be made on behalf of a party, for example, telemarketing calls to be made for a particular company or business entity. The customized caller ID telephone number 36 is assigned to a particular outbound call campaign and is configured as one of the campaign parameters or attributes. For example, a telephone number of the business entity associated with the outbound call campaign can be used as the customized caller ID telephone number 36 even though the call originates from the call center and not the business entity.

In the exemplary embodiment, the call record processor 40 is implemented in the call center management system 28 (see FIG. 1). In the Davox UNISON® system, for example, an outbound campaign manager retrieves the call records 32 for a particular outbound call campaign and initiates a telephony application client (TAC) to process the call records, for example, as disclosed in U.S. Pat. No. 5,592,543. To invoke the customized caller ID option in this exemplary embodiment, the TAC includes a caller ID field (T_caller_id), which is populated by a host provided download. The caller ID field (T caller id) includes digits (0-9) corresponding to the telephone number with a maximum of 32 digits. If the caller ID field exists, the telephone number from that field is sent along with the telephone number to be dialed to the ISDN connection device 42. In this exemplary embodiment, the ISDN connection device 42 is part of the Davox Digital Communications Server (DCS).

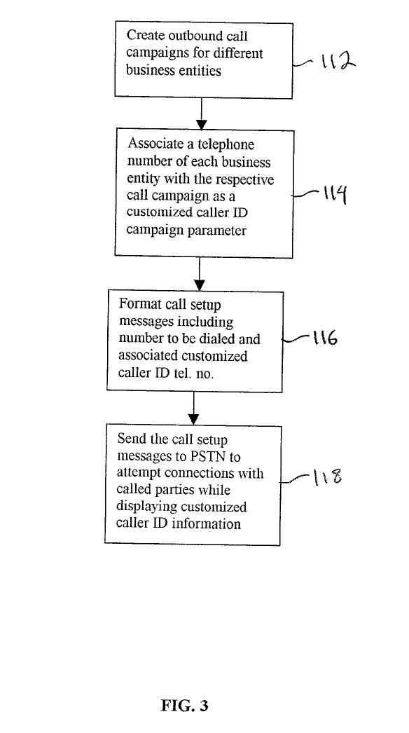

According to one exemplary method of using the present invention, shown in FIG. 3, a single call center is used to make calls for two different business entities or companies, ABC Co. and XYZ Inc, provides customized caller ID information for each of the respective companies. An outbound call campaign is created for each of the business entities or companies, step 112. The ABC Campaign includes a series of calls to be made on behalf of ABC Co., and the XYZ Campaign includes a series of calls to be made on behalf of XYZ Inc. The calls can include calls to the customers or potential customers of the respective company. Business telephone numbers are associated with the respective outbound call campaigns as the customized caller ID campaign parameter or attribute, step 114. For example, a corporate number for ABC Co. is associated with the ABC Campaign and a corporate number for XYZ Inc. is associated with the XYZ Campaign.

The call center processes the call campaigns for each of the companies, ABC Co. and XYZ Inc. Processing includes formatting call setup messages, as described above, with the telephone number to be dialed and the associated customized caller ID telephone number, step 116. For example, the call setup messages for customers of ABC Co. include the telephone number of the ABC customer being called and the corporate number for ABC Co., and the call setup messages for customers of XYZ Inc. include the telephone number of the XYZ customer being called and the corporate number for XYZ Inc. The call setup messages are sent over the ISDN line(s) of the call center to the PSTN to establish a telephonic connection, step 118.

The called parties who subscribe to the caller ID service are able to see the customized caller ID telephone number sent in the call setup message and any associated information (e.g., a name) in the telephone company database. When the calls for the ABC Campaign reach a called party having the caller ID service, the corporate number for ABC Co. is presented as the caller ID to the called party. When the calls for XYZ Campaign reach a called party having the caller ID service, the corporate number for XYZ Inc. is presented as the caller ID to the called party. Thus, the caller ID information presented to the called parties is customized for each company and campaign even though the calls originate from the phone lines of a single call center.

According to another exemplary method, a company can present different customized caller ID telephone numbers corresponding to different departments within the company, for example, different departments in a department store. According to this method, call campaigns are created for each of the departments and the department telephone number is associated with the call campaign as the customized caller ID campaign parameter.

Accordingly, the system and method of the present invention provides customized caller ID information to a called party and is not limited to the caller ID information that the telephone company has in its caller ID database for the line originating the call. In particular, the system and method can be used in a call center to customize the caller ID information to be presented to a called party based on the outbound call campaign, for example, so that a call back number for the entity associated with the campaign can be provided to the called party. Moreover, the calling party can use the systems and methods of the present invention to provide any, or no, callback information the calling party deems appropriate under the circumstances.

Modifications and substitutions by one of ordinary skill in the art are considered to be within the scope of the present invention, which is not to be limited except by the claims which follow.

What is claimed is:

1. A method of customizing caller identification (ID) information, said method comprising:
retrieving at least one call record including at least a telephone number to be dialed;
retrieving a customized caller ID telephone number associated with said at least one call record;
formatting a call setup message using an Integrated Services Digital Network (ISDN) protocol, wherein said call setup message includes said telephone number to be dialed and said customized caller ID telephone number; and
sending said call setup message to the Public Switched Telephone Network (PSTN) via an ISDN D channel, for connecting to a called party having said telephone number to be dialed, wherein said customized caller ID telephone number is displayed to said called party if said called party subscribes to a caller ID service on said PSTN.

2. The method of claim 1 wherein said at least one call record is associated with a call campaign having a plurality of call records representing outbound calls to be made, and wherein said customized caller ID telephone number is associated with said plurality of call records in said call campaign.

3. The method of claim 2 wherein said call campaign is being performed on behalf of a business entity, and wherein said customized caller ID telephone number is a telephone number for said business entity.

4. The method of claim 1 wherein said call setup message is sent over a primary rate interface (PRI) line.

5. The method of claim 1 wherein said method is performed in a call center having a database for storing said call records, call center management software for retrieving said call records and said customized caller ID telephone number, and a communications device for formatting and sending said call setup message.

6. A system for customizing caller identification (ID) information, said system comprising:
means for retrieving at least one call record including at least a telephone number to be dialed;
means for retrieving a customized caller ID telephone number associated with said at least one call record;
means for formatting a call setup message using an Integrated Services Digital Network (ISDN) protocol, wherein said call setup message includes said telephone number to be dialed and said customized caller ID telephone number; and
means for sending said call setup message to the Public Switched Telephone Network (PSTN) via an ISDN D channel, for connecting to a called party having said telephone number to be dialed, wherein said customized caller ID telephone number is displayed to said called party if said called party subscribes to a caller ID service on said PSTN.

7. The system of claim 6 wherein said at least one call record is associated with a call campaign having a plurality of call records representing outbound calls to be made, and wherein said customized caller ID telephone number is associated with said plurality of call records in said call campaign.

8. The system of claim 7 wherein said call campaign is being performed on behalf of a business entity, and wherein said customized caller ID telephone number is a telephone number for said business entity.

9. The system of claim 6 wherein said means for sending said call setup message is connected to a primary rate interface (PRI) line.

10. A system for customizing caller identification (ID) information, said system comprising:
a database for storing a plurality of call records;
a call record processor for retrieving at least one call record from said database, said call record including at least a telephone number to be dialed, and for retrieving a customized caller ID telephone number associated with said at least one call record; and
an Integrated Services Digital Network (ISDN) communications device, coupled to said call record processor, for formatting a call setup message using an ISDN protocol, wherein said call setup message includes said telephone number to be dialed and said customized caller ID telephone number, and for sending said call setup message to the Public Switched Telephone Network (PSTN) via an ISDN D channel, for connecting to a called party having said telephone number to be dialed, wherein said customized caller ID telephone number is displayed to said called party if said called party subscribes to a caller ID service on said PSTN.

11. The system of claim 10 wherein said plurality of call records stored in said database represent outbound calls to be made for a call campaign, and wherein said customized caller ID telephone number is associated with each of said plurality of call records in said call campaign.

12. The system of claim 11 wherein said call campaign is being performed on behalf of a business entity, and wherein said customized caller ID telephone number is a telephone number for said business entity.

13. The system of claim 10 wherein said ISDN communications device is connected to a primary rate interface (PRI) line.

14. A call center capable of providing customized caller identification (ID) information, said call center comprising:
a host database for storing a plurality of call records, each of said call records including at least a telephone number to be dialed;
a call center management system for retrieving and processing call records from said database, and for retrieving a customized caller ID telephone number associated with at least one of said call records;
a plurality of agent workstations for displaying call record information to agents;
a local area network (LAN) connecting said host database, said call center management system, and said agent workstations;
an Integrated Services Digital Network (ISDN) communications device for formatting a call setup message using an ISDN protocol, wherein said call setup message includes said telephone number to be dialed and said customized caller ID telephone number, and for sending said call setup message to the Public Switched Telephone Network (PSTN) via an ISDN D channel, for connecting to a called party having said telephone number to be dialed, wherein said customized caller ID telephone number is displayed to said called party if said called party subscribes to a caller ID service on said PSTN; and
a plurality of audio communications devices associated with respective ones of said plurality of agent workstations and connected to said ISDN communications device.

15. The call center of claim 14 wherein said call center management system processes said call records according to call campaigns, and wherein said customized caller ID telephone number is associated with one of said call campaigns.

16. The call center of claim 15 wherein said one of said call campaigns is being processed on behalf of a business entity, and wherein said customized caller ID telephone number is a telephone number for said business entity.

17. The call center of claim 14 wherein said ISDN communications device is connected to a primary rate interface (PRI) line.

18. A method of conducting outbound call campaigns in a call center using customized caller ID information, said method comprising:
creating at least first and second outbound call campaigns for respective first and second business entities, wherein said first and second outbound call campaigns are associated with first and second groups of call records;
associating first and second customized caller ID telephone numbers with respective first and second outbound call campaigns as campaign parameters, wherein said first customized caller ID telephone number is a telephone number of said first business entity, wherein said second customized caller ID telephone number is a telephone number of said second business entity; and
processing said first and second call campaigns, wherein processing includes:
formatting call setup messages for each of said outbound call campaigns using an ISDN protocol, wherein each of said call setup messages for said first outbound call campaign include a telephone number to be dialed from a call record in said first group of call records and include said first customized caller ID telephone number, wherein each of said call setup messages for said second outbound call campaign include a telephone number to be dialed from a call record in said second group of call records and include said second customized caller ID telephone number; and
sending said call setup messages over an ISDN line to the PSTN, for attempting to establish telephonic connections with called parties corresponding to said telephone numbers to be dialed, wherein said first customized caller ID telephone number is presented to called parties having caller ID service and corresponding to said first outbound call campaign and wherein said second customized caller ID telephone number is presented to called parties having caller ID service and corresponding to said second outbound call campaign.
